(19) United States
(12) Patent Application Publication
(10) Pub. No.: US 2015/0149379 A1
(43) Pub. Date: May 28, 2015

(54) Student Evaluation Enrollment System

(71) Applicant: Jacob Dearmon, Oklahoma City, OK (US)

(72) Inventor: Jacob Dearmon, Oklahoma City, OK (US)

(21) Appl. No.: 14/303,303

(22) Filed: Jun. 12, 2014

Related U.S. Application Data
(60) Provisional application No. 61/907,553, filed on Nov. 22, 2013.

(51) Int. Cl. G06Q 50/20; G06Q 10/00

(52) U.S. Cl. CPC G06Q 50/205; G06Q 10/00
USPC 705/326

(57) ABSTRACT

A student evaluation enrollment system may obtain two or more student associated variables. The system may determine a training population data set and a predictive population data set for the student associated variables. A probability distribution may be determined by applying at least one probabilistic model to the training population data set. Enrollment probability of the student population may then be determined by applying the probability distribution to the predictive population data set. A report may be created and distributed detailing the enrollment probability of the student population in accordance with the student associated variable.

### CROSS REFERENCE TO RELATED APPLICATION/INCORPORATION BY REFERENCE STATEMENT

The present patent application incorporates by reference the entire provisional patent application identified by U.S. Ser. No. 61/907,553, filed on Nov. 22, 2013, and claims priority thereto under 35 U.S.C. §119(e).

### BACKGROUND

Institutions, such as universities and colleges, may offer various forms of financial assistance to aid prospective and current students to enroll. Each student is typically evaluated based on a set of criteria to determine whether the student qualifies financially, athletically, academically, socially, and/or the like.

Institutions, however, also consider prospective enrollment of each student when offering financial assistance. For example, an institution may be given a set scholarship budget with a pre-determined objective that may determine the allocation of the scholarship budget. As such, institutions are looking to determine the best allocation of the scholarship budget with the relating student variables (e.g., high school GPA, ACT score, financial need) to meet the objective.

While many institutions may choose overall enrollment numbers as the defining objective, financially challenging times may leave many universities searching for objectives relating more towards their bottom line. As such, expected net revenue and expected net profit may become factors in determining offerings, enrollment, and allocation of money to students.

In determining the relationship between student variables (e.g., high school GPA, ACT score), scholarship amount, and the effect on enrollment, methods of estimating student's enrollment probability have typically involved the use of a fixed set of explanatory variables and a single technique, usually a logit or probit. The reliance on a fixed set of variables, a single technique is generally based on strong assumptions about the data generating process, and may be based on in-sample performance. These factors may lead to probabilistic estimates that are less accurate or robust. Some institutions may use a logistic relationship with a single model. For example, a single standard set of student variables would be selected and a probability assigned to each student. However, in mapping, this assumes that the relationship between the variables and student enrollment is monotonic and smooth, discounting other factors that may be indicative of why student(s) are enrolling.

Alternatively, some institutions may use a variable model with a step wise regression to identify the best student variables to use as it fits the model. While this approach does not include as many assumptions about the student variables, if a student variable not selected weighs heavily on enrollment decisions from one year to the next, the model fails to identify these variables.

### BRIEF DESCRIPTION OF THE SEVERAL VIEWS OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 is a schematic diagram of hardware forming an exemplary embodiment of a student evaluation enrollment system constructed in accordance with the present disclosure.

FIG. 2 is a block diagram of an exemplary embodiment of a host system according to the instant disclosure.

FIG. 3 is a block diagram of an exemplary embodiment of memory according to the instant disclosure.

FIG. 4 is a flowchart of an exemplary method for generating, providing, and/or storing a report related to a student inquiry.

FIG. 5 is an exemplary embodiment of a scholarship enrollment report for a student detailing a plurality of student associated variables in relation to scholarship allocation of an institution according to the present disclosure.

FIG. 6 is a flowchart of another exemplary method for generating, providing and/or storing a report related to a student inquiry.

FIG. 7 is an exemplary embodiment of a scholarship enrollment report for a plurality of students detailing ACT scores in relation to scholarship allocation according to the present disclosure.

FIG. 8 is an exemplary screenshot of an interactive feature providing drill down selection to view how a college and/or an individual student may be affected by alterations in tuition.

FIG. 9 is another exemplary screenshot of an interactive feature providing drill down selection to view how a college and/or an individual student may be affected by alterations in scholarship funding.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The disclosure is capable of other embodiments or of being practiced or carried out in various ways. Also, it is to be understood that the phraseology and terminology employed herein is for purposes of description, and should not be regarded as limiting.

The following detailed description refers to the accompanying drawings. The same reference numbers in different drawings may identify the same or similar elements.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

As used in the instant disclosure, the terms “provide”, “providing”, and variations thereof comprise displaying or providing for display a webpage (e.g., student evaluation webpage), electronic communications, e-mail, and/or electronic correspondence to one or more user terminals interfacing with a computer and/or computer network(s) and/or allowing the one or more user terminal(s) to participate, such as by interacting with one or more mechanisms on a webpage (e.g., first responder webpage), electronic communications, e-mail, and/or electronic correspondence by sending and/or receiving signals (e.g., digital, optical, and/or the like) via a computer network interface (e.g., Ethernet port, TCP/IP port, optical port, cable modem, combinations thereof, and/or the like). A user may be provided with a web page in a web browser, or in a software application, for example.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, any reference to “one embodiment,” “an embodiment,” “some embodiments,” “one example,” “for example,” or “an example” means that a particular element, feature, structure or characteristic described in connection with the embodiment is included in at least one embodiment. The appearance of the phrase “in some embodiments” or “one example” in various places in the specification is not necessarily all referring to the same embodiment, for example.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), field programmable gate array (FPGA), a combination of hardware and software, and/or the like.

Software may include one or more computer readable instructions that when executed by one or more components cause the component to perform a specified function. It should be understood that the algorithms described herein may be stored on one or more non-transient memory. Exemplary non-transient memory may include random access memory, read only memory, flash memory, and/or the like. Such non-transient memory may be electrically based, optically based, and/or the like.

It is to be further understood that, as used herein, the term user is not limited to a human being, and may comprise, a computer, a server, a website, a processor, a network interface, a human, a user terminal, a virtual computer, combinations thereof, and the like, for example.

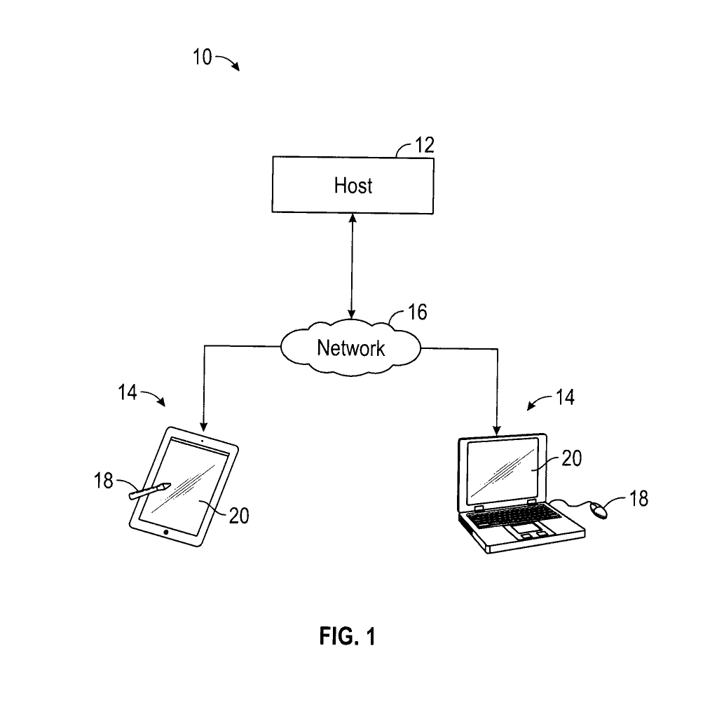

Referring now to the Figures, and in particular to FIG. 1, shown therein is a schematic diagram of hardware forming an exemplary embodiment of a student evaluation enrollment system 10 constructed in accordance with the present disclosure. Generally, the student evaluation enrollment system 10 may determine, store and/or provide one or more reports detailing a student's probability of enrollment at an institution given two or more student associated variables. For example, the student evaluation enrollment system 10 may determine, store and/or provide one or more reports detailing a student's probability of enrollment at an institution given a determinate amount of scholarship money afforded to the student. In some embodiments, the student evaluation enrollment system 10 may determine, store and/or provide one or more reports detailing a robust estimate of one or more student's probability of enrollment such that the probability of enrollment may scale in accordance with the scholarship dollar amount.

Referring to FIG. 1, the student evaluation enrollment system 10 may be a system or systems that are able to embody and/or execute the logic of the processes described herein. Logic embodied in the form of software instructions and/or firmware may be executed on any appropriate hardware. For example, logic embodied in the form of software instructions or firmware may be executed on dedicated system or systems, or on a personal computer system, or on a distributed processing computer system, and/or the like. In some embodiments, logic may be implemented in a stand-alone environment operating on a single computer system and/or logic may be implemented in a networked environment, such as a distributed system using multiple computers and/or processors.

In some embodiments, the student evaluation enrollment system 10 may include one or more host systems 12 communicating with one or more user devices 14. FIG. 1 illustrates the student evaluation enrollment system 10 having a single host system 12. It should be noted, however, that the student evaluation enrollment system 10 may include multiple host systems 12. In some embodiments, the host systems 12 may be partially or completely network-based or cloud based. The host system 12 may or may not be located in a single physical location. Additionally, multiple host systems 12 may or may not necessarily be located in a single physical location.

In some embodiments, the one or more host systems 12 and the one or more user devices 14 may be a single system located in a single physical location. For example, the one or more host systems 12 and the one or more user devices 14 may be a single personal computer.

In some embodiments, the one or more host systems 12 may be distributed and communicate with the one or more user devices 14 via a network 16. As used herein, the terms “network-based”, “cloud-based”, and any variations thereof, may include the provision of configurable computational resources on demand via interfacing with a computer and/or computer network, with software and/or data at least partially located on the computer and/or computer network, by pooling processing power of two or more networked processors.

In some embodiments, the network 16 may be the Internet and/or other network. For example, if the network 16 is the Internet, a primary user interface of the student evaluation enrollment system 10 may be delivered through a series of web pages. It should be noted that the primary user interface of the student evaluation enrollment system 10 may be replaced by another type of interface, such as a Windows-based application.

The network 16 may be almost any type of network. For example, the network 16 may interface by optical and/or electronic interfaces, and/or may use a plurality of network topographies and/or protocols including, but not limited to, Ethernet, TCP/IP, circuit switched paths, and/or combinations thereof. For example, in some embodiments, the network 16 may be implemented as the World Wide Web (or Internet), a local area network (LAN), a wide area network (WAN), a metropolitan network, a wireless network, a cellular network, a GSM network, a CDMA network, a 3G network, a 4G network, a satellite network, a radio network, an optical network, a cable network, a public switched telephone network, an Ethernet network, and/or combinations thereof. Additionally, the network 16 may use a variety of network protocols to permit bi-directional interface and/or communication of data and/or information. It is conceivable that in the near future, embodiments of the present disclosure may use more advanced networking topologies.

Each of the one or more host systems 12 may be capable of interfacing and/or communicating with the one or more user devices 14 via the network 16. For example, the one or more host systems 12 may be capable of interfacing by exchanging signals (e.g., analog, digital, optical, and/or the like) via one or more ports (e.g., physical ports or virtual ports) using a network protocol, for example. Additionally, each host system 12 may be capable of interfacing and/or communicating with other host systems directly and/or via the network 16, such as by exchanging signals (e.g., analog, digital, optical, and/or the like) via one or more ports.

The one or more user devices 14 may include, but are not limited to implementation as a personal computer, a smart phone, network-capable television set, a television set-top box, a tablet, an e-book reader, a laptop computer, a desktop computer, a network-capable handheld device, a video game console, a server, a digital video recorder, a DVD player, a Blu-Ray player, and combinations thereof, for example. In some embodiments, the user device 14 may include on or more input devices 18, one or more output devices 20, one or more processors capable of interfacing with the network 16, processor executable code, and/or a web browser capable of accessing a website and/or communicating information and/or data over a network, such as network 16. As will be understood by persons of ordinary skill in the art, the one or more user devices 14 may include one or more non-transient memory comprising processor executable code and/or software applications, for example. Current embodiments of the student evaluation enrollment system 10 may also be modified to use any of these user devices 14 or future developed devices capable of communicating with one or more host systems 12 via the network 16.

The one or more input devices 18 may be capable of receiving information input from a user and/or processor(s), and transmitting such information to the user device 14 and/or to the network 16. The one or more input devices 18 may include, but are not limited to, implementation as a keyboard, touchscreen, mouse, trackball, microphone, fingerprint reader, infrared port, slide-out keyboard, flip-out keyboard, cell phone, PDA, video game controller, remote control, fax machine, network interface, and combinations thereof, for example.

The one or more output devices 20 may be capable of outputting information in a form perceivable by a user and/or processor(s). For example, the one or more output devices 20 may include, but are not limited to, implementations as a computer monitor, a screen, a touchscreen, a speaker, a website, a television set, a smart phone, a PDA, a cell phone, a fax machine, a printer, a laptop computer, and combinations thereof, for example. It is to be understood that in some exemplary embodiments, the one or more input devices 18 and the one or more output devices 20 may be implemented as a single device, such as, for example, a touchscreen or a tablet. It is to further understood that as used herein the term user is not limited to a human being, and may comprise, a computer, a server, a website, a processor, a network interface, a human, a user terminal, a virtual computer, and combinations thereof, for example.

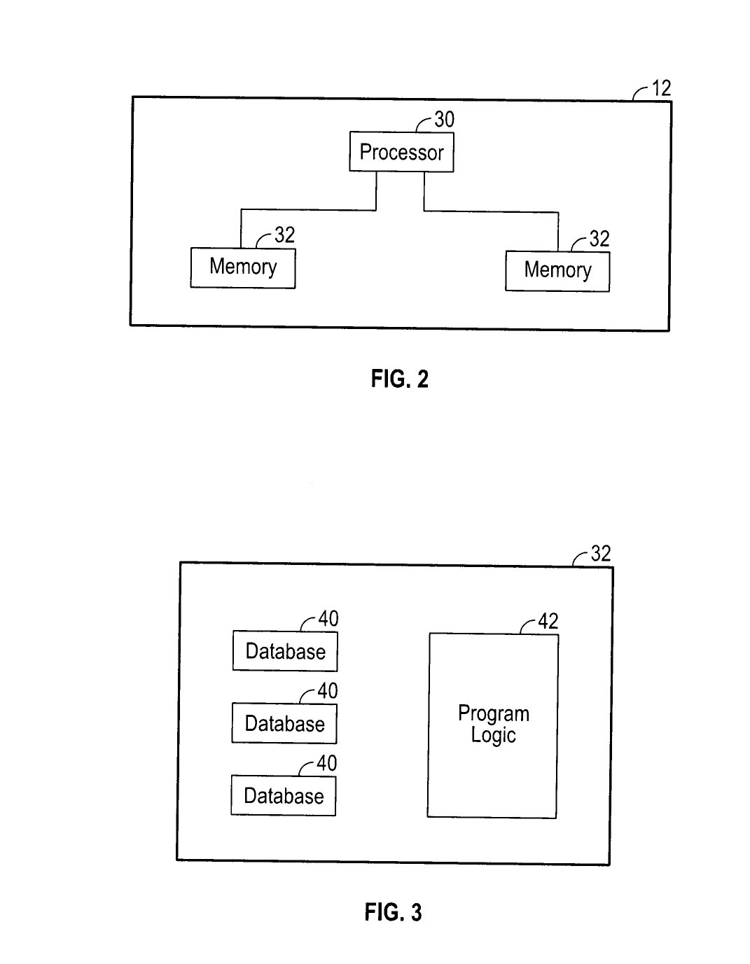

Referring to FIGS. 1 and 2, in some embodiments, the one or more host systems 12 may include one or more processors 30 working together, or independently to execute processor executable code, and one or more memories 32 capable of storing processor executable code. In some embodiments, each element of the host system 12 may be partially or completely network-based or cloud based, and may or may not be located in a single physical location.

The one or more processors 30 may be implemented as a single or plurality of processors working together, or independently, to execute the logic as described herein. Exemplary embodiments of the one or more processors 30 may include, but are not limited to, a digital signal processor (DSP), a central processing unit (CPU), a field programmable gate array (FPGA), a microprocessor, a multi-core processor, and/or combinations thereof, for example. The one or more processors 30 may be capable of communicating with the one or more memories 32 via a path (e.g., data bus).

The one or more processors 30 may be capable of interfacing and/or communicating with the one or more user devices 14. In some embodiments, the one or more processors 30 may be capable of communicating via the network 16 by exchanging signals (e.g., analog, digital, optical, and/or the like) via one or more ports (e.g., physical or virtual ports) using a network protocol). It is to be understood, that in certain embodiments, using more than one processor 30, the processors 30 may be located remotely from one another, in the same location, or comprising a unitary multi-core processor. The one or more processors 30 may be capable of reading and/or executing processor executable code and/or capable of creating, manipulating, retrieving, altering, and/or storing data structures into one or more memories 32.

The one or more memories 32 may be capable of storing processor executable code. Additionally, the one or more memories 32 may be implemented as a conventional non-transient memory, such as, for example, random access memory (RAM), a CD-ROM, a hard drive, a solid state drive, a flash drive, a memory card, a DVD-ROM, a floppy disk, an optical drive, and/or combinations thereof, for example.

In some embodiments, one or more memories 32 may be located in the same physical location as the host system 12. Alternatively, one or more memories 32 may be located in a different physical location as the host system 12, with the host system 12 communicating with the one or more memories 32 via the network 16. Additionally, one or more of the memories 32 may be implemented as a “cloud memory” (i.e., one or more memories 32 may be partially or completely based on or accessed using the network 16).

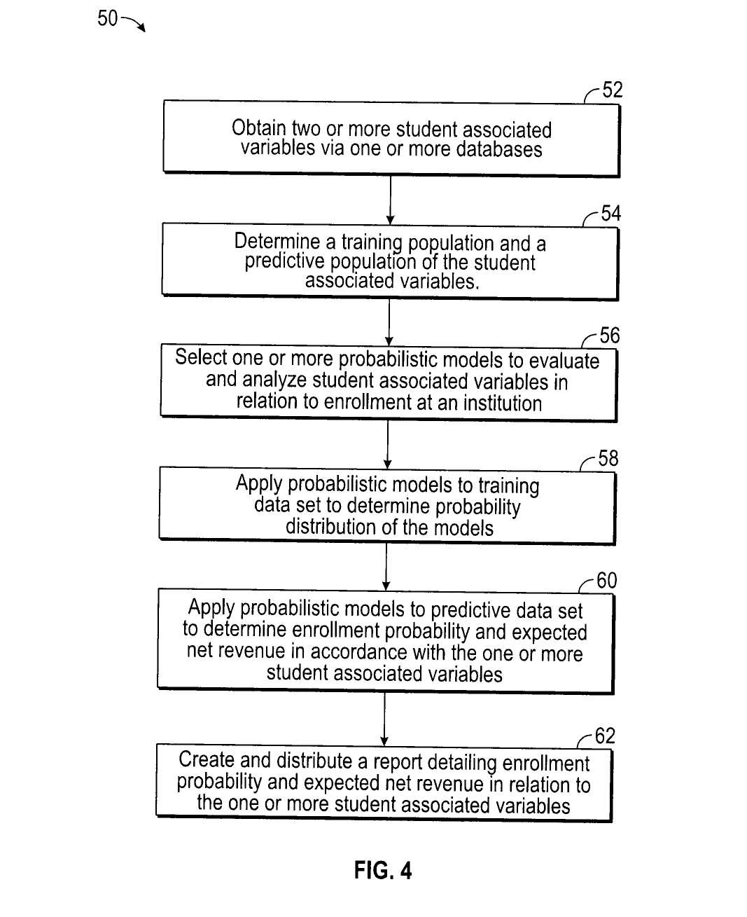

Referring to FIGS. 1-3, the one or more memories 32 may store processor executable code and/or information comprising one or more databases 40 and program logic 42. In some embodiments, the processor executable code may be stored as a data structure, such as a database and/or a data table, for example.

In some embodiments, one or more databases 40 may store one or more student associated variables for access and analysis by host system 12. Student associated variables may include, but are not limited to, enrollment indicators (e.g., freshman, sophomore, junior, senior), academic input qualities (e.g., high school GPA, college GPA, ACT score, GRE score, SAT score), current academic performance (e.g., midterm GPA, semester GPA, cumulative GPA), athletic interest (e.g., intent to play), Free Application for Federal Student Aid (FAFSA) rank, personal demographics (e.g., age, gender, religion, distance from home, cost of living), financial characteristics (e.g., tuition costs, fees, housing, remission, scholarships, grants, loans, athletics), financial burdens (e.g., expected family contribution), institutional investment (e.g., number of hours currently enrolled, institutional hours accumulated), social integration (e.g., membership participation, membership role), academic integration (e.g., major, school), external demographics (e.g., census data), student identification, time trends (e.g., first year, second year, third year), and/or the like, for example.

In some embodiments, the one or more processors 30 and/or memories 32 may extract student associated variables using a student information system database such as Banner®, distributed by Ellucian with headquarters located in Fairfax, Va. Additionally, one or more databases 40 may derive information from outside third party sources. For example, in measuring a student's social integration, one or more databases 40 may access and analyze network connections derived from social network data, including group membership role, membership participation of the student, and/or the like.

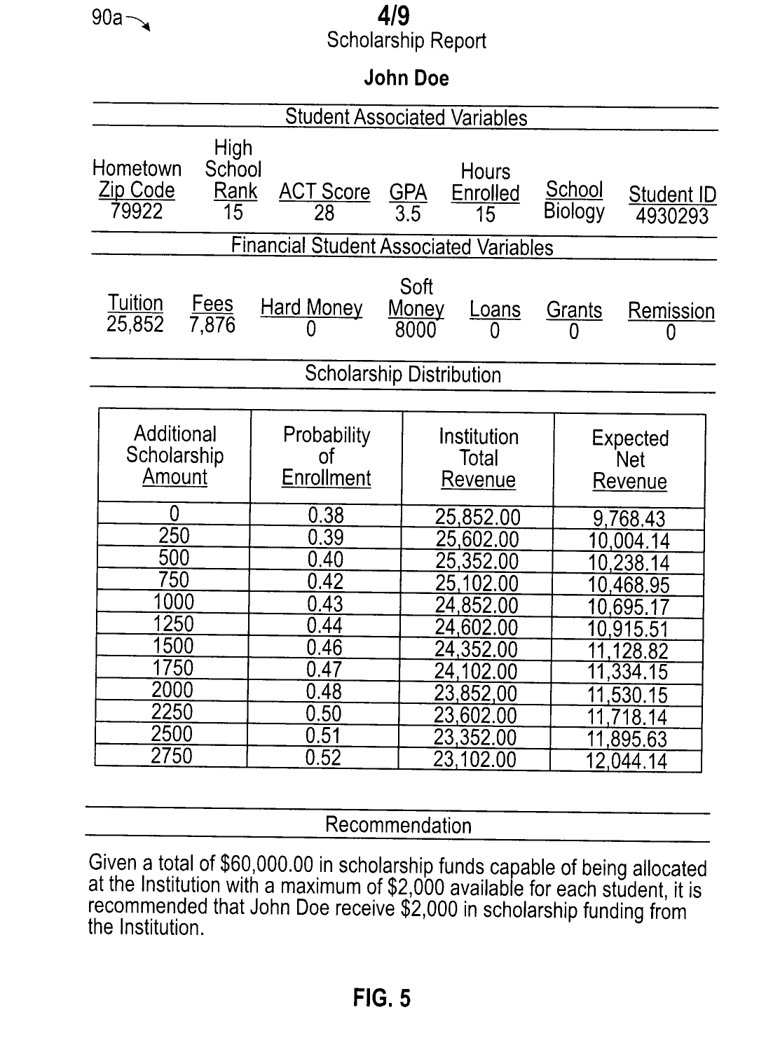

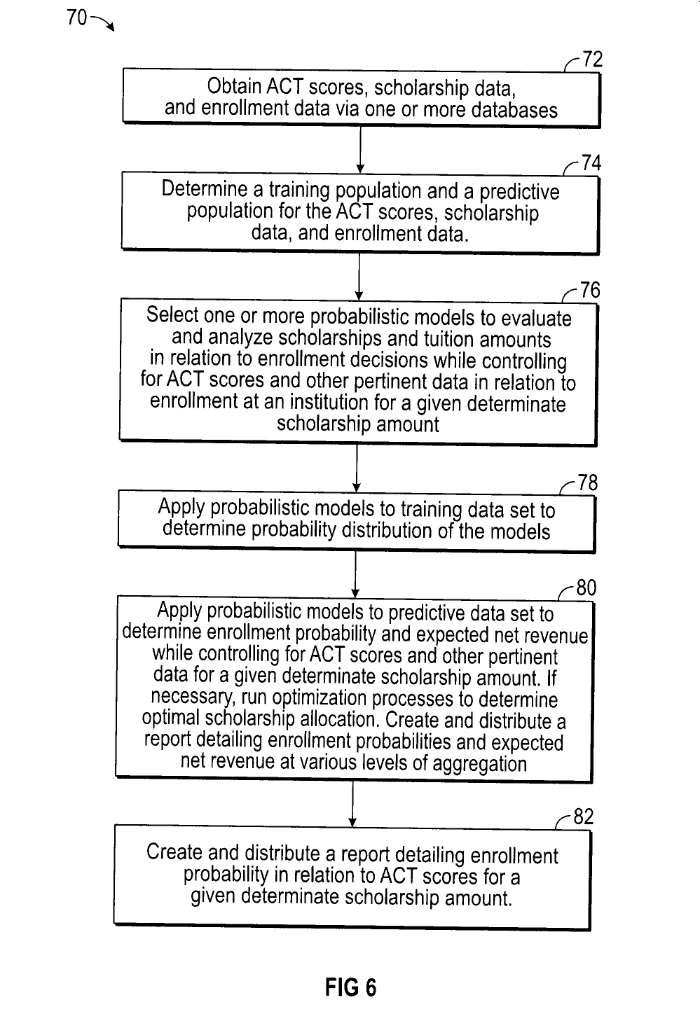

FIG. 4 illustrates a flow chart 50 of an exemplary method for constructing one or more reports detailing one or more student's probability of enrollment at an institution given a determinate set of student associated variables. In some embodiments, the one or more reports may detail one or more student's probability of enrollment at an institution given a determinate amount of scholarship money afforded to the student by the institution by using a determinate set of student associated variables. For example, FIG. 5 illustrates an exemplary report 90a wherein the probability of enrollment for a student, John Doe, at an institution is detailed given determinate amount of scholarship money afforded to John Doe by the institution using student associated variables, including financial variables.

An institution may include, but is not limited to, educational institutions such as colleges, universities, charter schools, public schools, private schools, elementary schools, middle schools, high schools, day schools, and/or the like. For example, one or more reports 90a may be constructed detailing one or more student associated variables in relation to enrollment at a university. Even further, one or more reports 90a may be constructed detailing one or more students' probability of enrollment at a university given a determinate amount of scholarship money afforded to the student as illustrated in FIG. 5. It should be noted that the term “enrollment” is not limited to a first time enrollee, and may include all matriculating students.

In some embodiments, the institution may be any society or organization founded for a religious, educational, social or similar purpose. To that end, the term “student” may be any person, prospective member, or active member of an organization or institution qualifying, seeking, or relying on scholarship funding. For example, one or more reports 90a may be constructed detailing one or more prospective members' probability of enrollment within a fraternal organization given a determinate amount of scholarship money afforded to the prospective member.

In some embodiments, the institution may be an insurance company or an employer. To that end, the one or more reports 90a may detail one or more potential applicant's (employees′) and/or current enrollee's (employees') probability of accepting and/or continuing coverage (employment) given a determinate amount of premium (salary). Student associated variables may also be referred to as insured associated variables (employee associated variables), and may further include current coverage, past coverage, current employment, past employment, degree obtained, prior work experience, and/or the like.

Referring to the flow chart 50 illustrated in FIG. 4, in a step 52, one or more student associated variables may be obtained by the host system 12 via the one or more databases 40. For example, student associated variables such as, ACT/SAT score, undergraduate GPA, FAFSA Rank, Athletics Intent to Play, tuition cost, fee costs, housing cost, other sources of funding (e.g., grants, scholarships, loans), expected family contribution, number of hours currently enrolled, school, census data, and/or the like, may be obtained via a database 40. Additionally, scholarship distribution from the university may be included as a student associated variable.

The report 90a illustrated in FIG. 5 includes the student associated variables of hometown zip code, high school ranking, ACT score, GPA, the number of hours enrolled, the school within the institution, student ID, as well as several financial student associated variables including tuition, fees, hard money, soft money, loans, grants, remission. Additionally, the scholarship distribution from the institution may be included as illustrated in FIG. 5. It should be noted, however, that any student associated variable may be used to determine probability of enrollment and is not limited to the student associated variables detailed in FIG. 5.

In some embodiments, data from the one or more databases 40 may be pre-processed prior to extraction by the host system 12 to detail one or more student associated variables. For example, one or more queries may be run on the one or more databases 40 to extract specific information (e.g., query based) from the one or more databases 40. In some embodiments, one or more sub-queries, inner queries, or nested queries may also be run on the one or more databases 40 to detail one or more student associated variables. For example, tuition and fees for admitted, but not enrolled, students in prior years may be imputed using a set of nested queries. The nested queries may identify and/or attribute tuition and/or fees from similar, but enrolled, students. Queries, sub-queries, inner queries, and/or nested queries may be stored and/or provided by the host system 12 and/or one or more databases 40.

In a step 54, the host system 12 may divide student associated variables into at least one of two sets: a training data set and a predictive data set. In some embodiments, the dependent variable (e.g., y variable) in both datasets may be a zero or one enrollment indicator, with zero indicating no enrollment and one indicating enrollment. Student associated variables may influence a student's enrollment decision (e.g., explanatory variables). The relationship between the enrollment indicator and the explanatory variables may be estimated using statistical techniques on the training dataset determining a probability. For example, for every 100 additional miles a student resides from home, enrollment probability of the student may drop by 5%, ceteris paribus.

From the training data set, one or more subsets of student associated variables may be selected. Generally, the one or more subsets of student associated variables may be assigned probabilities derived from the data. Across all different subsets, the probabilities sum to unity (i.e., one).

In a step 56, one or more probabilistic models may be selected by the host system 12 to determine probability distribution. The training data set may include data by which one or more probabilistic models determine probability distributions. Probabilistic models may include, but are not limited to, Gaussian Process Regression, Support Vector Machines, and/or the like. Generally, the techniques may use covariance functions or kernels (e.g., squared exponential, neural network kernels, and/or the like), to address unknown nonlinearities that may be present in the data. Other kernels may also be used including, but not limited to, periodic, polynomial, matern, and/or the like. In addition, one or more combinations of kernal types may be used including, but not limited to, product, addition, and/or the like).

In a step 58, the one or more probabilistic models selected by the host system 12 may be applied to the training data of the one or more databases 40 to evaluate enrollment probability.

Training of each technique subset combination may include use of historical student data as a hold-out data set. For example, the training data set may include student associated variables from the years 2009-2011, and the hold-out data set may include the same student associated variables from the year 2012. The techniques, having been trained on the years 2009-2011, may classify each student's enrollment decision in 2012.

Using an ensemble averaging technique, weight may be assigned to probabilistic models based on misclassification rates on the hold-out data set. For example, in some embodiments, probabilistic models may be combined using an ensemble averaging technique such as a variant of the AdaBoost algorithm. Generally, the AdaBoost algorithm may increase probabilistic weight assigned to techniques correctly classifying the most difficult enrollment decisions. For example, the AdaBoost algorithm may increase probabilistic weight of probabilistic models that correctly classify enrollment decisions that are most often misclassified by other probabilistic models such if a first probabilistic model has no misclassification errors, then that technique would receive a weight of one. If a first probabilistic model misclassifies a single observation, and a second probabilistic model correctly classifies it, then the weight of the first probabilistic model may decrease while the weight of the second probabilistic model may increase. The total weight across all probabilistic models sums to one.

In a step 60, the one or more probabilistic models with predetermined probabilistic rankings selected by the host system 12 may be applied to the predictive data set. For example, the probabilistic distribution may be applied to the predictive data set to detail one or more students' probability of enrollment at an institution given a determinate student associated variables and/or amount of scholarship money afforded to the student. As described above, weight may be assigned to probabilistic models based on misclassification rates on the hold-out set within the training data set. Given these subset weights, a forecast probability of a student's enrollment decision for the prediction data set using, for example, year 2013 data may be determined.

In some embodiments, net revenue for each student may also be determined. For example, net revenue may include financial considerations including, but not limited to, tuition, fees, housing (e.g., housing minus non-endowed), soft discounts, employee remission, and/or the like. Net revenue and probability determinations as described herein may yield expected net revenue and/or expected net profit. For example, the probability that a student enrolls may be conditional on student associated variables in view of net revenue that the student may generate with enrollment.

With probability of enrollment and expected net revenue for each student, forecasts of students/classes may be determined for different levels. For example, levels may include departments, schools, universities, and/or the like. Forecasts may include enrollment forecasts, expected net revenue forecasts, and/or the like. Additionally, forecasts may include forecasts of student associated variables including ACT score forecasts, and/or the like.

In some embodiments, expected net revenue and probability of enrollment may be forecast over a pre-determined amount of time. For example, net revenue from an admitted student may include probability of enrolling as a freshman, and may further include probability of enrolling as a sophomore conditional on enrolling as a freshman, probability of enrolling as a junior conditional on enrolling as a freshman and/or sophomore, and probability of enrolling as a senior conditional on enrolling as a freshman, sophomore, and/or junior. Even further, the pre-determined amount of time may include probability of donating funds as alumni of the institution.

Even further, insight into effective changes to student factors (e.g., tuition increase, scholarship increase) may be determined and the effect this may have on enrollment and/or net revenue may be analyzed. For example, changes in student factors may be determined using the methods described herein to allocate scholarship dollars. Increased scholarship budget may affect financial (e.g., net expected revenue) and/or non-financial outcomes (e.g., expected ACT) at various levels of aggregation within the institution. Alterations in scholarship allocation may affect expected net revenue and/or probability of enrollment.

Allocation of a fixed set of scholarship dollars across a pool of admitted student may be determined based on the greatest gain in expected net revenue across individuals while controlling for input quality. For example, if a user would like to control for input quality of the entering class, student associated variables of ACT scores and/or net revenue may be controlled such that a user may define whether more weight is given to expected net revenue or alternatively input quality of the student entering student population. As such, weight of ACT scores may be increased.

Allocation of scholarship dollars for groups of qualifying students (e.g., students found in a scholarship matrix demarcated by ACT ranges), may also be determined such that expected net revenue may be maximized. For example, if a low amount of scholarship dollars is given, then the probability of enrollment may be lower. As scholarship dollars increased, probability of enrollment will increase to a certain level, and may plateau at a range of expected net revenue. This amount of expected net revenue may then be considered to be the maximum for a set scholarship amount.

In some embodiments, the methods described herein may be used for tuition determination. For example, adjustment of variables, such as tuition, and the corresponding effect on each student's enrollment probability and/or expected net revenue may be discerned. These student level effects may then be included across levels at the institution to allow for a data-driven analysis of the setting of tuition.

In some embodiments, the methods described herein may be used for retention analysis. For example, changes in social network metrics (e.g., measures of centrality constructed off of group membership rolls) may be used to assess possible changes in retention probabilities to aid Student Affairs of an institution to determine allocation of funds across a variety of projects and/or programs.

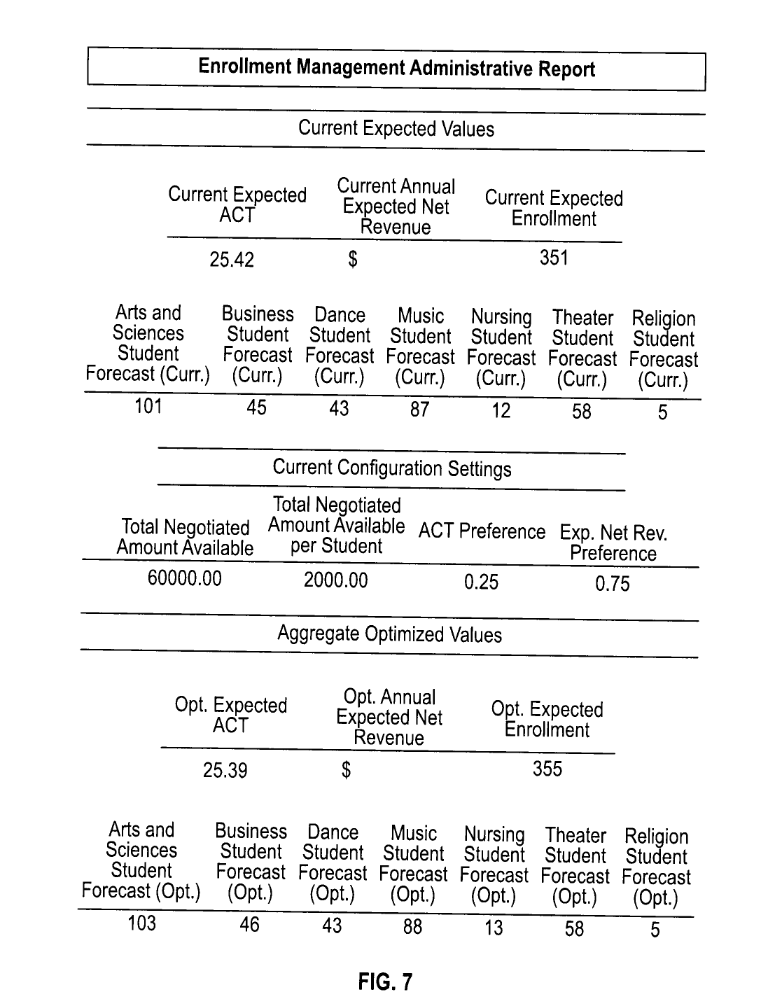

In a step 62, one or more reports 90 may be generated detailing one or more student enrollment factors of the institution using determinations of the probabilistic models as described herein. For example, one or more reports may detail a student's probability of enrollment scaled in an appropriate fashion with the scholarship amount afforded to that student as illustrated in FIG. 6. In some embodiments, one or more reports 90 may include one or more maps and/or graphs. For example, one or more reports 90 may include a graphical representation of expected net revenue in view of additional scholarship amount allocated to a student. Additionally, one or more maps may illustrate expected enrollment numbers by state, expected net revenue by state, expected ACT scores by state, and/or the like. Visual and/or spatial representations of the data as described herein may be illustrated and/or provided.

In some embodiments, the report 90 may detail one or more student associated variables for review by a user. For example, the report 90 includes a student associated variable section and a financial associated variable section having multiple student associated variables therein. Additionally, the report 90 may include one or more sections detailing probability of enrollment in relation to one or more student associated variables. For example, the report 90 includes a scholarship section detailing the probability of enrollment in relation to allocation of scholarship funding. The probabilistic models and the methods described herein may determine the student's probability of enrollment in relation to the scholarship amount afforded to that student taking into consideration student associated variables, including financial student associated variables.

In some embodiments, the one or more reports 90a may be constructed detailing one or more students' probability of enrollment at multiple institutions given a set of student associated variables using the methods as described in FIG. 4. For example, the report 90a may provide and/or detail one or more students' probability of enrollment at one or more colleges and/or universities within the university system given determinate amounts of scholarship money given at each college and/or university. The report 90a, illustrated in FIG. 5, includes student associated variables such as hometown zip code, high school ranking, ACT score, GPA, the number of hours enrolled, the school within the institution, student ID, as well as several financial student associated variables including tuition, fees, hard money, soft money, loans, grants, and remission. Each of these student associated variables may be included within the determination and recommendation on the amount of scholarship funds to allocate to the student.

In some embodiments, the one or more reports 90 may be constructed detailing one or more student's probability of enrollment in different programs within the university given determinate student associated variables. For example, the one or more reports 90 may provide and/or detail a distinction between two different programs (e.g., Life Science vs. Business) and determinate amounts of scholarship money given by the different programs and/or the university, in that additional scholarship money may be available to a student within one program versus the other. Determination of scholarship amounts in relation to student associated variables may be constructed using the methods as described in FIG. 4.

The report 90a illustrates probability of enrollment as scaled with scholarship distribution from the institution, however, it should be noted that probability of enrollment may be scaled with any student associated variable considered viable for review. For example, probability of enrollment may be scaled in relation to tuition cost. If an institution is reviewing raising tuition costs, probability of enrollment may be scaled with tuition costs and may also include consideration of other student associated variables such as school (e.g., Biology, Business), GPA, distance from hometown, and/or other student associated variables deemed relevant for review.

It should be noted, that the one or more reports 90 may be interactive reports. For example, in some embodiments, a user may be able to select a variable for identification on the one or more reports 90 using one or more user devices 14 communicating via the host system 12. The one or more user devices 14 may request variations of the one or more reports 90 based on selection of the student associated variables of interest. For example, the one or more reports 90 may be focused on ACT scores and the relation to scholarship data for a single student. The user may select SAT scores and ACT score adding in another student associated variable to the methods described above, with the one or more reports 90 adjusting outcome accordingly.

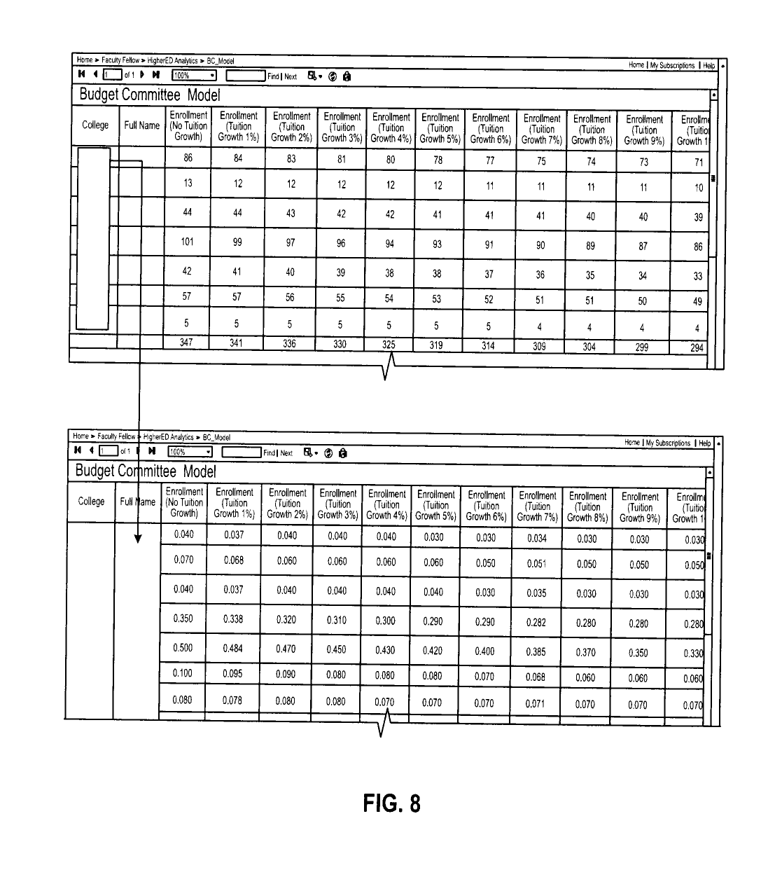

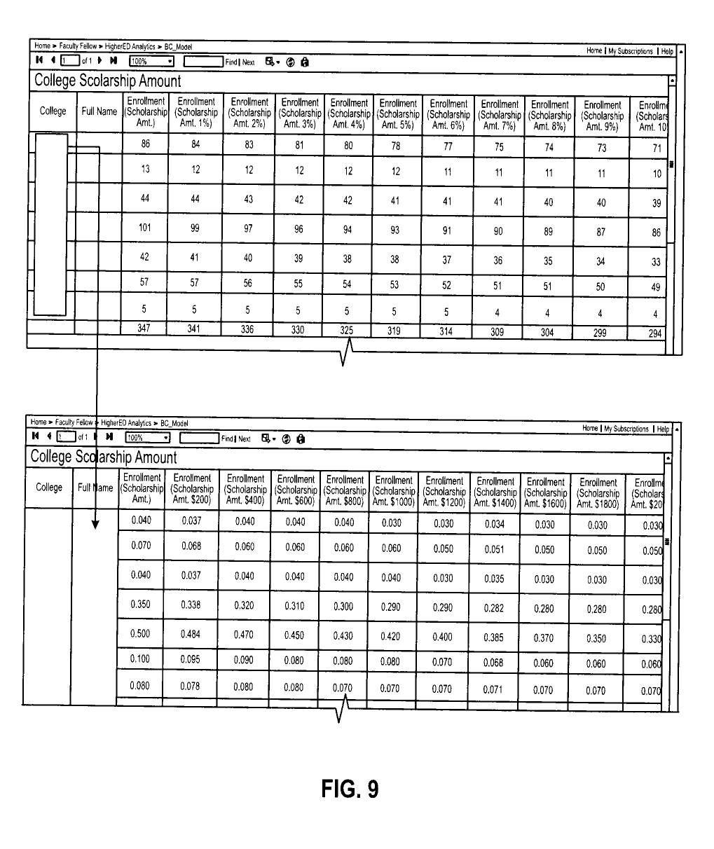

Additionally, in some embodiments, the one or more reports may display one or more levels of aggregation with drill down capabilities. For example, as illustrated in FIG. 8, general information regarding expected net revenue at the institution level may be illustrated with an interactive feature providing drill down selection to view how an individual student may be affected by a change in tuition. A scholarship matrix may also include drill down functionality, as illustrated in FIG. 9, to display changes in scholarship dollars allocated to a group and/or individual, and the effect on the groups' expected enrollment and/or expected net revenue.

FIG. 6 illustrates a flow chart 70 of another exemplary method for constructing one or more reports detailing the probability of enrollment at an institution using student associated variables. In this example, the probability of enrollment at an institution may be detailed given a determinate amount of scholarship money afforded to student(s) in relation to ACT score using the methods as described in FIG. 4. Based on the probability of enrollment, an institution may determine a recommendation for giving student(s) with a particular ACT score a determinate amount of scholarship money. In some embodiments, the recommendation may also be determinate on expected net revenue of one or more students.

In a step 72, the student associated variables for ACT score and scholarship amount allocated to each student may be obtained by the host system 12 via the one or more databases 40. It should be noted that additional student associated variables may be included in the following determinations. Additionally, in some embodiments, one or more financial associated variables may be determined for each student.

In a step 74, the host system 12 may divide the student associated variables for ACT score, scholarship amount, and/or financial associated variables allocated to each student into at least one of two sets: a training data set and a predictive data set. For example, the training data set may include ACT scores and scholarship amounts from the years 2009-2012, and the predictive data set may include ACT scores and scholarship amounts for the year 2013.

In a step 76, one or more probabilistic models may be selected by the host system 12 to determine probability of enrollment of one or more students based on ACT score given a determinate amount of scholarship funds given to the student(s). In some embodiments, the financial associated variables for each student may be included in the determination of probability of enrollment. The training data set may include data by which the one or more probabilistic models determine the probability distributions. Probabilistic models may include, but are not limited to, Gaussian Process Regression, Support Vector Classifications and/or the like.

In a step 78, the one or more probabilistic models selected by the host system 12 may be applied to the training data set of the one or more databases 40 to evaluate sample performance and determine probabilistic model ranking. Training of each technique subset combination may include use of historical student data as a hold-out data set. For example, the training data set may include student associated variables from the years 2009-2011, and the hold-out data set may include the same student associated variables from the year 2012. The techniques, having been trained on the years 2009-2011, may classify each student's enrollment decision in 2012. Using an ensemble averaging technique, weight may be assigned to probabilistic models based on misclassification rates on the hold-out data set, such as a variant of the AdaBoost algorithm as described herein.

In a step 80, the one or more probabilistic models selected by the host system 12 may be applied to the predictive data set of the one or more databases 40. For example, the probabilistic distribution may be applied to the predictive data set to detail one or more students' probability of enrollment scaled with a determinate scholarship amount afforded to that student in relation to ACT scores. In some embodiments, financial associated variables may be included in the determination. As described herein, weight may be assigned to probabilistic models based on misclassification rates on the hold-out set within the training data set. Given these subset weights, a forecast probability of a student's enrollment decision and expected net revenue using the prediction dataset may be determined.

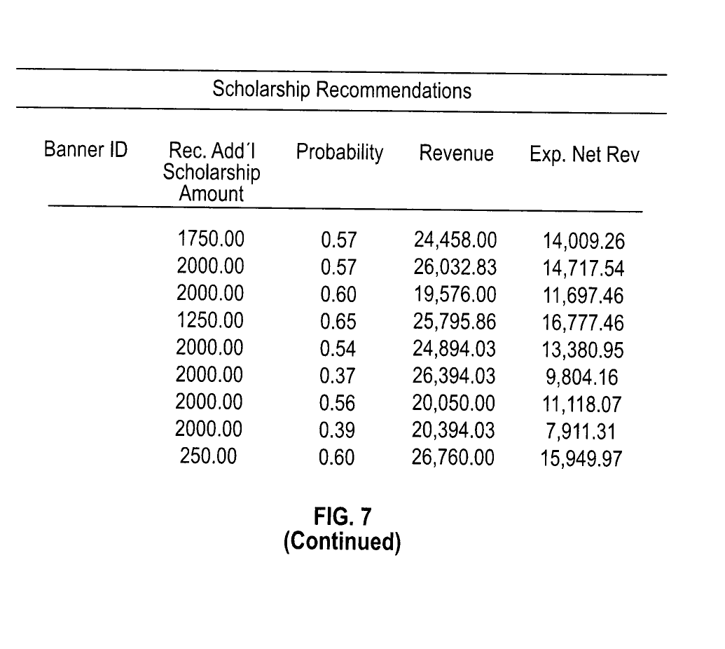

In a step 82, one or more reports 90 may be generated detailing student(s) probability of enrollment scaled with the scholarship amount afforded to that student in relation to ACT score. For example, FIG. 7 illustrates an exemplary report 90b detailing pre-optimized forecasts under an assumption of scholarship dollars allocated. As such, in some embodiments, FIG. 7 may assume that no additional scholarship dollars may be awarded. In some embodiments, the reports may also include detailing of expected net revenue. Generally, reports 90b may be included for enrollment management reporting.

Report 90b may include several student associated variables including, but not limited to, expected ACT, expected enrollment, and expected net revenue. Such factors may be determined based on allocated scholarship amounts. The scholarship amounts may be displayed at additional levels of aggregation including, but not limited to, school, department, and/or university.

Report 90b, in some embodiments, may also include configurations settings. Configuration settings may drive global allocation of scholarships. For example, a user may be able to adjust scholarship allocation using the configuration settings to increase or decrease allocation amount of the scholarship.

Report 90b may include results of the methods provided in FIG. 6. Results of the methods provided in FIG. 6 may be determined at one or more levels of aggregation. For example, results of the methods provided in FIG. 6 may be determined at the school, department, and/or university level. Such results may include expected net revenue, expected ACT, enrollment probability, and/or the like.

In some embodiments, report 90b may include one or more recommendations using the methods provided in FIG. 6. For example, report 90b may include one or more recommendations regarding each non-zero scholarship recommendation. Additionally, report 90b may include one or more additional student associated variables including, but not limited to, student banner identification number, probability of enrollment of a student, net revenue, expected net revenue, and/or the like.

In some embodiments, one or more spatial and/or visual forecasts may be determined and/or provided to a user in the report 90b. For example, report 90b may include one or more maps having forecasts (e.g., optimized, non-optimized), data (e.g., Census data), and/or the like.

In some embodiments, one or more reports 90 may be interactively linked. For example, report 90a may be linked to report 90b such that information determined by each report 90 may be stored and/or provided to a user.

In some embodiments, firms may use the methods described herein to price discriminate between individual consumers. For example, each consumer generally has a certain probability of purchasing a good at a given price times the profit and/or revenue that they may then generate should the consumer purchase at that price. As such, the methods described herein may be used to set a price for an individual consumer such that profits and/or revenues may be maximized.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. A computer processing system, comprising:
a host system having at least one processor; and,
at least one computer readable medium storing a set of instructions that when executed by the processor cause at least one processor to:
obtain enrollment data and at least one student associated variable from at least one database;
determine a training population data set and a predictive population data set for the enrollment data and the at least one student associated variable;
determine a probability distribution by applying at least one probabilistic model to the training population data set;
determine enrollment probability of a student population by applying the probabilistic model using the probability distribution to the predictive population data set; and,
create a report detailing the enrollment probability of the student population in accordance with the student associated variable.

2. The system of claim 1, wherein the student population includes a single person at an institution.

3. The system of claim 1, wherein the step of instructions further includes determining expected net revenue of an institution in relation to the student associated variable.

4. The system of claim 3, wherein the report further details enrollment probability and expected net revenue at multiple levels of aggregation.

5. The system of claim 4, wherein step of instructions further includes varying at least one student associated variable and analyzing variances in relation to expected net revenue and enrollment probability.

6. The system of claim 1, wherein the report further includes detailing expected net revenue of an institution in relation to the student associated variable.

7. The system of claim 1, wherein at least one student variable includes scholarship distribution of an institution.

8. The system of claim 7, wherein the report further details the enrollment probability of the student population given a determinate amount of scholarship money afforded to the student population.

9. The system of claim 1, wherein the training population data set further includes at a first data set and a second data set, the second data set providing a hold-out data set, and the set of instructions that when executed by the processor cause at least one processor to further:
determine a probability distribution by applying at least one probabilistic model to the first data set of the training population data set; and,
assign a weight to the probabilistic model based on misclassification rates as the probability distribution is applied to the second data set.

10. The system of claim 1, wherein the set of instructions that when executed by the processor cause at least one processor to further identify an optimal allocation of scholarship dollars using an optimization algorithm.

11. A computer processing system, comprising:
a host system having at least one processor; and,
at least one computer readable medium storing a set of instructions that when executed by the processor cause at least one processor to:
obtain at least one student associated variable, scholarship data and enrollment data of at least one institution from at least one database;
determine a training population data set and a predictive population data set for the at least one student associated variable, scholarship data and enrollment data;
apply at least one probabilistic model to the training data set to determine probability distribution of the probabilistic model;
apply the probabilistic model using the probability distribution to the predictive data set to determine enrollment probability while controlling for the at least one student associated variable for a given determinate scholarship range; and,
create a report detailing enrollment probabilities based on the probabilistic model in relation to the at least one student associate variable for the determinate scholarship range.

12. The system of claim 11, wherein the set of instructions further causes the processor to:
determine expected net revenue of the institution while controlling for the student associated variable; and,
create a report detailing expected net revenue of the institution based on the determinate scholarship range.

13. The system of claim 11, wherein at least one student associated variable includes data derived from a social network database.

14. A method of evaluating student enrollment at an institution, comprising:
obtaining enrollment data and at least one student associated variable from at least one database;
determining a training population data set and a predictive population data set for the enrollment data and the student associate variable;
applying a plurality of probabilistic models to the training population data set to determine a probability distribution for the probabilistic models;
applying the plurality of probabilistic models based on the probability distribution to the predictive data set to determine enrollment probability in relation to the at least one student associated variable; and,
creating a report detailing the enrollment probability in relation to the at least one student associated variable.

15. The method of claim 14, further comprising the step of determining expected net revenue in relation to the at least one student associated variable, wherein the report includes the expected net revenue as applied to enrollment probability and the at least one student associated variable.

16. The method of claim 14, wherein at least one student associated variable includes scholarship distribution.

17. The method of claim 16, the method further comprising
determining expected net revenue in relation to the scholarship distribution; and,
determining allocation of scholarship funds such that expected net revenue is maximized.

18. The method of claim 14, wherein at least one student associated variable includes student financial considerations.

19. The method of claim 14, further comprising:
determining the probability distribution by applying at least one probabilistic model to a first data set of the training population data set; and,
assigning a weight to the probabilistic model based on misclassification rates as the probability distribution is applied to a second data set of the training population data set.

20. The method of claim 14, wherein at least one student associated variable is derived from tuition cost.

21. The method of claim 14, wherein at least one student associated variable includes tuition cost.

22. The method of claim 14, wherein the report is a user interactive report.
